(19) United States
(12) Patent Application Publication
(10) Pub. No.: US 2024/0235244 A9
(43) Pub. Date: Jul. 11, 2024

(54) ELECTRONIC APPARATUS, METHOD FOR ELECTRONIC APPARATUS, AND STORAGE MEDIUM

(71) Applicant: CANON KABUSHIKI KAISHA, Tokyo (JP)

(72) Inventor: HIROSHI MASHIMO, Tokyo (JP)

(21) Appl. No.: 18/400,595

(22) Filed: Dec. 29, 2023

Related U.S. Application Data
(63) Continuation of application No. PCT/JP2022/024258, filed on Jun. 17, 2022.

(30) Foreign Application Priority Data
Jul. 2, 2021 (JP) 2021-110608

(51) Int. Cl. H02J 7/00; H02J 50/80

(52) U.S. Cl. CPC H02J 7/007192; H02J 7/00041; H02J 7/00309; H02J 50/80

(57) ABSTRACT

An electronic apparatus includes a power transmission unit configured to wirelessly transmit power to a power reception apparatus, and a control unit configured to perform control to display information indicating that the power reception apparatus is being charged in a case where the power transmission unit is transmitting power, and to stop displaying the information indicating that the power reception apparatus is being charged in a case where the power transmission unit has stopped power transmission, wherein the power transmission unit transitions from a normal mode to a power-saving mode based on information about the power reception apparatus, the power-saving mode having a period of time from when the power transmission unit stops the power transmission to when the power transmission unit starts power transmission for detecting an object longer than the period of time of the normal mode.

### CROSS-REFERENCE TO RELATED APPLICATIONS

This application is a Continuation of International Patent Application No. PCT/JP2022/024258, filed Jun. 17, 2022, which claims the benefit of Japanese Patent Application No. 2021-110608, filed Jul. 2, 2021, both of which are hereby incorporated by reference herein in their entireties.

### BACKGROUND

### Field

The present disclosure relates to an electronic apparatus, a control method for the electronic apparatus, and a storage medium.

### Background Art

Technologies for wireless power transmission systems have been widely developed. PTL 1 discusses a power transmission apparatus and a power reception apparatus that are compliant with Wireless Power Consortium (WPC) standards established by the WPC that is a standard-setting organization of wireless charging standards.

### CITATION LIST

### Patent Literature

PTL 1: Japanese Patent Application Laid-Open No. 2015-56959

A power transmission apparatus is required to detect whether a new power reception apparatus is placed even after charging is completed. Accordingly, the power transmission apparatus transmits a signal for detecting an object immediately after the charging is completed and power transmission is stopped, and then the power transmission apparatus transmits a signal for detecting a power reception apparatus. After the power transmission apparatus transmits the latter signal, in the power reception apparatus left on the power transmission apparatus after the charging is completed, a charging unit therein is activated, so that the power transmission from the power transmission apparatus to the power reception apparatus is resumed. Along with this process, information indicating that charging is in process may be displayed on an apparatus incorporating the power transmission apparatus in some cases. After that, the power transmission apparatus detects a fully charged state and stops the power transmission again, and then stops display of the information indicating that the charging is in process. Such operations may be repeatedly carried out in some cases, causing repetition of display and non-display of the information indicating that the charging is in process. This is inconvenient for a user and is an issue to be addressed.

### SUMMARY

The present disclosure is directed to preventing repetition of display and non-display of information indicating that a power reception apparatus is being charged.

According to an aspect of the present disclosure, an electronic apparatus includes a power transmission unit configured to wirelessly transmit power to a power reception apparatus, and a control unit configured to perform control to display information indicating that the power reception apparatus is being charged in a case where the power transmission unit is transmitting power, and to stop displaying the information indicating that the power reception apparatus is being charged in a case where the power transmission unit has stopped power transmission, wherein the power transmission unit transitions from a normal mode to a power-saving mode based on information about the power reception apparatus, the power-saving mode having a period of time from when the power transmission unit stops the power transmission to when the power transmission unit starts power transmission for detecting an object longer than the period of time of the normal mode.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of an electronic apparatus.

FIG. 2 is a block diagram illustrating a configuration example of a power transmission apparatus.

FIG. 3 is a block diagram illustrating a configuration example of a power reception apparatus.

FIG. 4 is a sequence diagram for the power transmission apparatus and the power reception apparatus.

FIG. 5 is a sequence diagram for the electronic apparatus, the power transmission apparatus, and the power reception apparatus.

FIG. 6A is a diagram illustrating a display example of a display unit of the electronic apparatus.

FIG. 6B is a diagram illustrating a display example of the display unit of the electronic apparatus.

FIG. 6C is a diagram illustrating a display example of the display unit of the electronic apparatus.

FIG. 7 is a flowchart illustrating a processing example of the power transmission apparatus.

FIG. 8 is a sequence diagram for the electronic apparatus, the power transmission apparatus, and the power reception apparatus.

FIG. 9 is a flowchart illustrating a processing example of the power transmission apparatus.

### DESCRIPTION OF THE EMBODIMENTS

### First Exemplary Embodiment

Exemplary embodiments will be described in detail below with reference to the drawings. Multiple features are described in the exemplary embodiments. However, not all the features are essential and the features may be combined as appropriate. Further, in the drawings, the same reference numerals are given to the same or similar components.

### Configuration of Electronic Apparatus

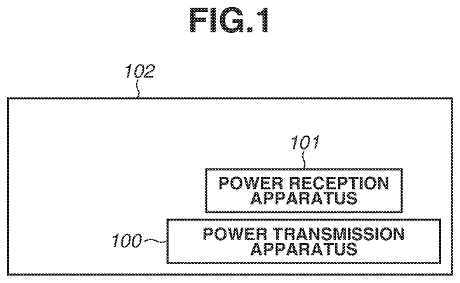

FIG. 1 is a diagram illustrating a configuration example of an electronic apparatus 102 according to a first exemplary embodiment. The electronic apparatus 102 is a wireless power transmission system, and includes, for example, a power reception apparatus 101 and a power transmission apparatus 100. The power transmission apparatus 100 wirelessly transmits power to the power reception apparatus 101. The power reception apparatus 101 receives power from the power transmission apparatus 100 and charges a built-in battery. The electronic apparatus 102 is an electronic apparatus incorporating at least the power transmission apparatus 100. The electronic apparatus 102 is, for example, an automobile or a camera. The electronic apparatus 102 may be a smartphone, a tablet personal computer (PC), a laptop computer, a robot, a medical apparatus, a printer, a headset, or any other apparatus.

### Configuration of Each Apparatus

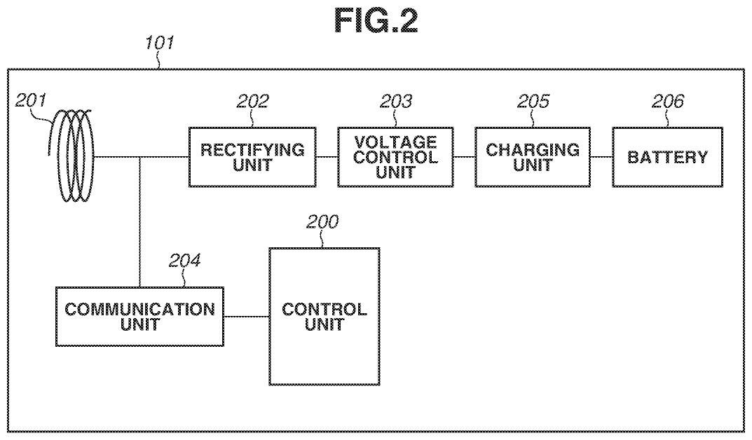

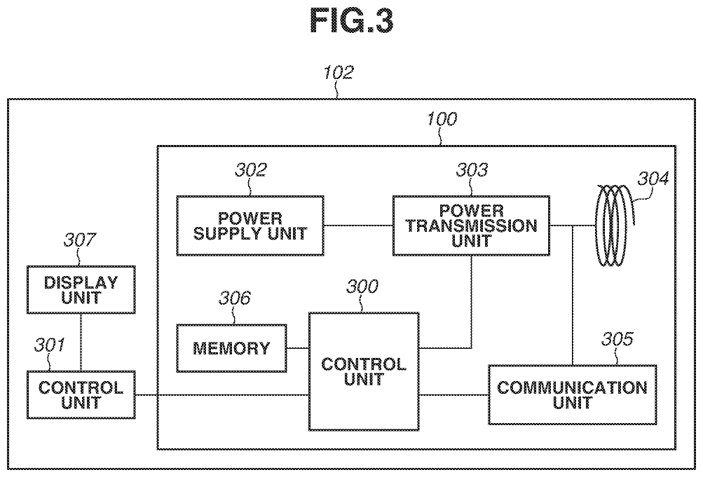

FIG. 2 is a diagram illustrating a configuration example of the power reception apparatus 101 illustrated in FIG. 1. The power reception apparatus 101 is compliant with a Wireless Power Consortium (WPC) standard, and includes a control unit 200, a power reception coil 201, a rectifying unit 202, a voltage control unit 203, a communication unit 204, a charging unit 205, and a battery 206. The control unit 200 controls the entire power reception apparatus 101. An example of the control unit 200 is a central processing unit (CPU). The power reception coil 201 receives power from a power transmission coil 304 (FIG. 3) of the power transmission apparatus 100. The rectifying unit 202 converts an alternating-current voltage and an alternating current received from the power transmission coil 304 through the power reception coil 201 into a direct-current voltage and a direct current. The voltage control unit 203 converts the level of the direct-current voltage received from the rectifying unit 202 into the level of the direct-current voltage at which the control unit 200, the charging unit 205, and the like operate. The charging unit 205 charges the battery 206 with the direct-current voltage converted by the voltage control unit 203. The communication unit 204 performs wireless charging control communication with a communication unit 305 (FIG. 3) of the power transmission apparatus 100 based on the WPC standard. The control communication is implemented by executing load modulation of the alternating-current voltage and the alternating current received through the power reception coil 201.

The power reception apparatus 101 may be incorporated in another apparatus (a camera, a smartphone, a tablet PC, a laptop computer, an automobile, a robot, a medical apparatus, or a printer) that is different from the electronic apparatus 102.

FIG. 3 is a diagram illustrating a configuration example of the power transmission apparatus 100 illustrated in FIG. 1. The electronic apparatus 102 includes the power transmission apparatus 100, a control unit 301, and a display unit 307. The power transmission apparatus 100 is compliant with the WPC standard and includes a control unit 300, a power supply unit 302, a power transmission unit 303, the power transmission coil 304, the communication unit 305, and a memory 306. The control unit 300 controls the entire power transmission apparatus 100. An example of the control unit 300 is a CPU. The power supply unit 302 supplies power to each functional block of the power transmission apparatus 100. The power supply unit 302 is, for example, a commercial power supply or a battery. The battery stores the power supplied from the commercial power supply.

The power transmission unit 303 converts direct-current or alternating-current power input from the power supply unit 302 into alternating-current power in a frequency band used for wireless power transmission, and inputs the alternating-current power to the power transmission coil 304, thereby generating electromagnetic waves for causing the power reception apparatus 101 to receive power. For example, the power transmission unit 303 converts the direct-current voltage supplied from the power supply unit 302 into an alternating-current voltage by a switching circuit having a half bridge or full bridge configuration using a field-effect transistor (FET). In this case, the power transmission unit 303 includes a gate driver that controls on/off of the FET.

Further, the power transmission unit 303 adjusts either a voltage (power transmission voltage) or a current (power transmission current), or both of them, or a frequency, thereby controlling the intensity of electromagnetic waves to be output. As the power transmission unit 303 increases the power transmission voltage or the power transmission current, the intensity of electromagnetic waves increases, and as the power transmission unit 303 decreases the power transmission voltage or the power transmission current, the intensity of electromagnetic waves decreases. The control unit 300 controls the power transmission unit 303 to start or stop the power transmission through the power transmission coil 304, and controls the output of the alternating-current power from the power transmission unit 303. The power transmission unit 303 is capable of supplying power for outputting power of 15 watts (W) to the charging unit 205 of the power reception apparatus 101 compliant with the WPC standard.

The communication unit 305 communicates with the power reception apparatus 101 to control the power transmission based on the WPC standard through the power transmission coil 304. The communication unit 305 executes frequency modulation (frequency shift keying) of the alternating-current voltage and the alternating current output from the power transmission unit 303, and transfers information to the power reception apparatus 101 to perform communication. Further, the communication unit 305 demodulates the alternating-current voltage and the alternating current modulated in the communication unit 204 of the power reception apparatus 101, thereby acquiring information transmitted from the power reception apparatus 101. Specifically, the communication unit 305 performs communication by superimposing a signal on the electromagnetic waves transmitted from the power transmission unit 303. Further, the communication unit 305 may communicate with the power reception apparatus 101 by communication based on a standard different from the WPC standard using a coil different from the power transmission coil 304 (or an antenna), or may communicate with the power reception apparatus 101 by selectively using a plurality of communications.

The memory 306 is configured to store not only a control program, but also states of the power transmission apparatus 100 and the power reception apparatus 101 and the like. For example, the state of the power transmission apparatus 100 is acquired by the control unit 300. The state of the power reception apparatus 101 is acquired by the control unit 200 of the power reception apparatus 101. The control unit 300 receives the state of the power reception apparatus 101 from the power reception apparatus 101 via the communication unit 305.

The display unit 307 displays the state of the power transmission apparatus 100, or the state of the electronic apparatus 102 including the power transmission apparatus 100 and the power reception apparatus 101 as illustrated in FIG. 1, thereby informing a user of the state. While the present exemplary embodiment describes an example where a display is used as the display unit 307, any other component, such as a speaker for audio output, a vibration generation circuit, or a light-emitting diode (LED), may be used as long as the component is capable of informing the user of the state as described above.

The control unit 301 is a control unit mounted on the electronic apparatus 102 incorporating the power transmission apparatus 100, and controls the display unit 307. A wired or wireless communication path is provided between the control unit 301 and the control unit 300 of the power transmission apparatus 100, and the control unit 301 receives information about the power transmission apparatus 100 and the power reception apparatus 101.

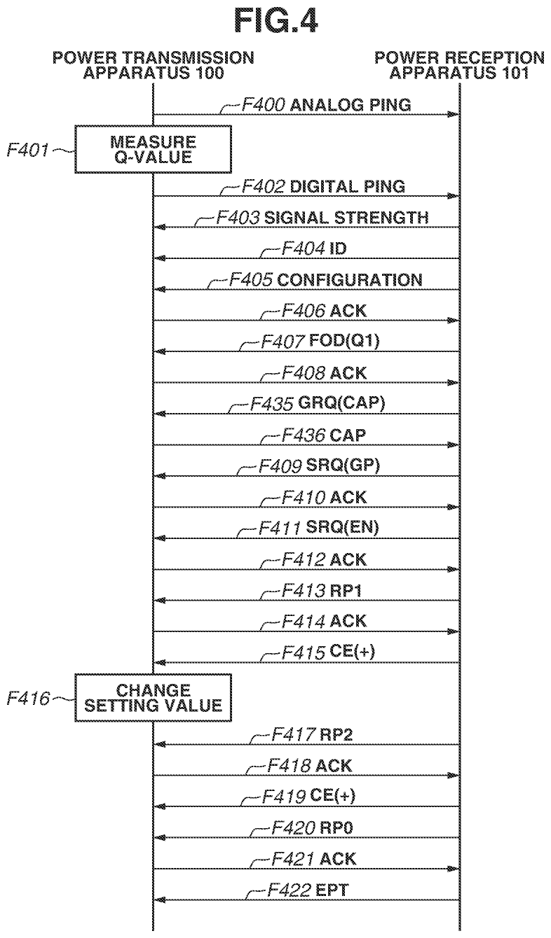

FIG. 4 is a sequence diagram for the power transmission apparatus 100 and the power reception apparatus 101 according to the present exemplary embodiment. A procedure of a control method for the power transmission apparatus 100 and the power reception apparatus 101 that are compliant with the WPC standard v1.2.3 will now be described with reference to the sequence diagram of FIG. 4.

In step F400, the power transmission apparatus 100 transmits an analog ping to detect an object present in the vicinity of the power transmission coil 304. The analog ping is pulsed power for detecting an object. The analog ping is power that is too small to start the control unit 200 of the power reception apparatus 101 even if the power reception apparatus 101 receives the analog ping. The power transmission apparatus 100 detects an object based on a shift in resonance frequency of a voltage value in the power transmission coil 304, or a change in the voltage value or a current value of the power transmission coil 304 due to the presence of the object in the vicinity of the power transmission coil 304.

In step F401, upon detecting an object by the analog ping, the power transmission apparatus 100 measures a Q-value of the power transmission coil 304 by Q-value measurement. In step F402, the power transmission apparatus 100 starts transmission of a digital ping after the Q-value measurement. The digital ping is power that is used to start the control unit 200 of the power reception apparatus 101 and is larger than the analog ping. After that, the digital ping is continuously transmitted. Specifically, the power transmission apparatus 100 continues to transmit power that is larger than the digital ping from when the transmission of the digital ping is started (step F402) to when an end power transfer (EPT) packet to be described below is received from the power reception apparatus 101 (step F422).

In step F403, upon receiving the digital ping, the power reception apparatus 101 starts up and transmits a Signal Strength packet storing the voltage value of the received digital ping to the power transmission apparatus 100.

Next, in step F404, the power reception apparatus 101 transmits version information about the WPC standard with which the power reception apparatus 101 is compliant and an identification (ID) including device identification information to the power transmission apparatus 100. In step F405, the power reception apparatus 101 transmits a Configuration packet storing information including a maximum value of power supplied to a load (charging unit 205) to the power transmission apparatus 100.

In step F406, the power transmission apparatus 100 determines that the power reception apparatus 101 is compliant with an extension protocol (including Negotiation to be described below) of the WPC standard v1.2 or later based on the ID and the Configuration packet. Then, the power transmission apparatus 100 sends a response to the power reception apparatus 101 by an Acknowledgement (ACK) for the Configuration packet.

In step F407, upon receiving the ACK, the power reception apparatus 101 transitions to a Negotiation phase in which negotiation on power to be transmitted and received is performed. First, the power reception apparatus 101 transmits a foreign object detection (FOD) status to the power transmission apparatus 100. In the present exemplary embodiment, the FOD status is represented by FOD(Q1).

In step F408, the power transmission apparatus 100 performs foreign object detection based on a first foreign object detection method using a Q-value stored in FOD(Q1) and the Q-value obtained by the Q-value measurement, and transmits ACK indicating that it is highly likely that there is no foreign object to the power reception apparatus 101. The term “foreign object” used in the present disclosure refers to an object different from the power reception apparatus 101. Examples of the foreign object include a clip and an integrated circuit (IC) card. Among the objects indispensable for the power reception apparatus 101 or a product incorporating the power reception apparatus 101 or the power transmission apparatus 100 or a product incorporating the power transmission apparatus 100, an object that can unintentionally generate heat when the object is exposed to wireless power transmitted from a power transmission antenna is not regarded as the foreign object.

In step F409, upon receiving the ACK, the power reception apparatus 101 performs negotiation on Guaranteed Power that is the maximum value of power requested to be received by the power reception apparatus 101. The Guaranteed Power is load power (power to be consumed by the load) of the power reception apparatus 101, and the power is agreed between the power transmission apparatus 100 and the power reception apparatus 101. Specifically, the power reception apparatus 101 transmits a packet storing the above-described value of the Guaranteed Power requested by the power reception apparatus 101 in a Specific Request specified in the WPC standard to the power transmission apparatus 100. In the present exemplary embodiment, this packet is represented by SRQ(GP).

In step F410, the power transmission apparatus 100 sends a response to the SRQ(GP) packet described above to the power reception apparatus 101 in consideration of the power transmission capability of the power transmission apparatus 100 and the like. Specifically, the power transmission apparatus 100 determines that the above-described Guaranteed Power can be accepted, and transmits ACK indicating that the above-described request is accepted to the power reception apparatus 101. In the present exemplary embodiment, it is assumed that the power reception apparatus 101 has requested 15 watts as the Guaranteed Power in SRQ(GP).

In step F411, upon completion of negotiation on a plurality of parameters including the Guaranteed Power, the power reception apparatus 101 transmits SRQ(EN) for requesting an end of the negotiation in the Specific Request to the power transmission apparatus 100. The end of the negotiation is referred to as End Negotiation.

In step F412, the power transmission apparatus 100 transmits ACK for the above-described SRQ(EN) to the power reception apparatus 101. Then, the power transmission apparatus 100 ends the Negotiation and transitions to a Power Transfer phase in which power defined in the Guaranteed Power is transmitted and received.

Next, the power transmission apparatus 100 and the power reception apparatus 101 perform second foreign object detection based on a power loss calculated using transmitted power and received power. In the present exemplary embodiment, a Received Power Packet (mode 1) is represented by RP1 and a Received Power Packet (mode 2) is represented by RP2.

In step F413, the power reception apparatus 101 transmits the RP1 to the power transmission apparatus 100. The power transmission apparatus 100 receives the RP1 from the power reception apparatus 101.

In step F414, the power transmission apparatus 100 transmits ACK indicating that a received power value stored in the RP1 and a transmitted power value of the power transmission apparatus 100 at the time are accepted as Calibration Data Point to the power reception apparatus 101.

In step F415, the power reception apparatus 101 transmits Control Error (hereinafter abbreviated as CE) for requesting the power transmission apparatus 100 to increase or decrease a received voltage (a received current or received power) to the power transmission apparatus 100. The CE stores a sign and a numerical value. If the sign is plus, it indicates a request for increasing power, and if the sign is minus, it indicates a request for decreasing power. If the numerical value is zero, it indicates a request for maintaining power. For example, the power reception apparatus 101 transmits CE(+) indicating a request for increasing power to the power transmission apparatus 100.

In step F416, upon receiving CE(+), the power transmission apparatus 100 changes a setting value of the power transmission unit 303 that supplies the received power to the load, to thereby increase the transmitted power.

In step F417, when the received power increases in response to CE(+), the power reception apparatus 101 supplies the received power to the load and transmits RP2 to the power transmission apparatus 100.

In step F418, the power transmission apparatus 100 transmits ACK for RP2 to the power reception apparatus 101. Calibration processing has been described above. Subsequently, the power transmission apparatus 100 performs foreign object detection based on a second foreign object detection method.

At this point, the power transmission apparatus 100 and the power reception apparatus 101 have transitioned to a Power Transfer phase. The power transmission apparatus 100 transmits power so that the power reception apparatus 101 receives maximum power of 15 watts negotiated in the Negotiation phase.

In step F419, the power reception apparatus 101 transmits CE indicating a request for increasing or decreasing the received power to the power transmission apparatus 100. For example, the power reception apparatus 101 transmits CE(+) indicating a request for increasing the power to the power transmission apparatus 100.

In step F420, the power reception apparatus 101 transmits a Received Power packet (mode 0) storing the current received power value to the power transmission apparatus 100. In the present exemplary embodiment, the received power packet (mode 0) is represented by RP0. The power reception apparatus 101 regularly transmits CE in step F419 and RP0 in step F420 to the power transmission apparatus 100.

In step F421, upon receiving RP0 from the power reception apparatus 101, the power transmission apparatus 100 performs foreign object detection based on the second foreign object detection method (power loss method) based on a power loss calculated based on the transmitted power and the received power. The power transmission apparatus 100 transmits ACK indicating that the power transmission apparatus 100 has determined that it is highly likely that there is no foreign object as a result of the foreign object detection to the power reception apparatus 101.

In step F422, upon completion of charging, the power reception apparatus 101 transmits an EPT packet to request the power transmission apparatus 100 to stop the power transmission.

Upon receiving the EPT packet, the power transmission apparatus 100 stops the power transmission. Then, the processing returns to step F400 described above to repeat the same operation. The procedure of the control method for the power transmission apparatus 100 and the power reception apparatus 101 that are compliant with the WPC standard v1.2.3 has been described above.

### Issues in the Present Exemplary Embodiment

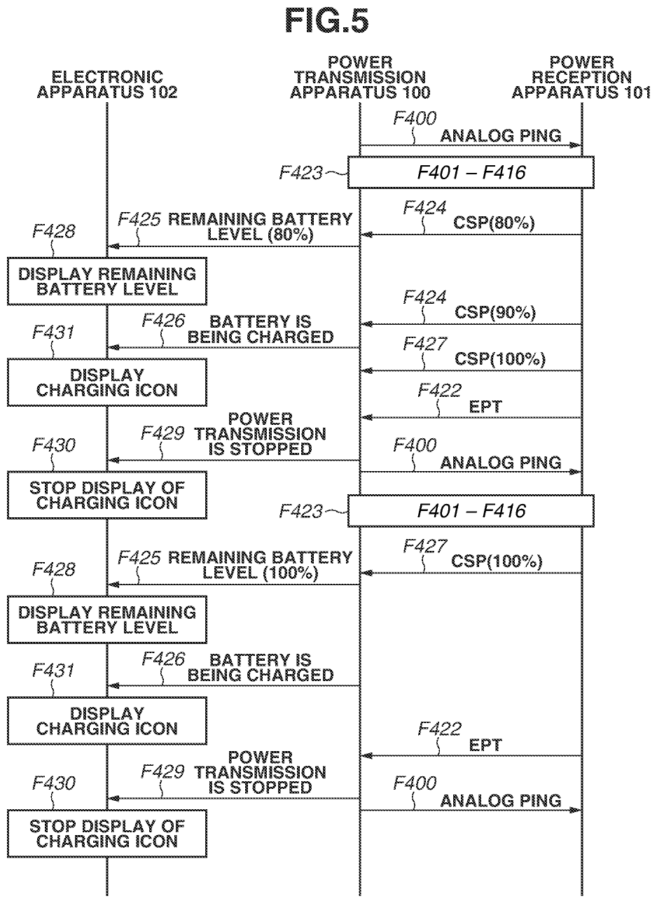

FIG. 5 is a sequence diagram illustrating a control method for the electronic apparatus 102, the power transmission apparatus 100, and the power reception apparatus 101. Issues in the present exemplary embodiment will be described with reference to FIG. 5. Steps identical to those described above with reference to FIG. 4 are denoted by the same step numbers, and descriptions thereof may be omitted.

In step F400, the power transmission apparatus 100 transmits an analog ping to the power reception apparatus 101. In step F423, the power transmission apparatus 100 and the power reception apparatus 101 perform processing of steps F401 to F416 illustrated in FIG. 4 described above, and then transition to the Power Transfer phase to start power transmission.

In step F424, the power reception apparatus 101 transmits a Charge Status packet indicating a remaining battery level of the battery 206 to the power transmission apparatus 100. The Charge Status packet is expressed as CSP in the present exemplary embodiment. For example, the power reception apparatus 101 transmits CSP(80%) to the power transmission apparatus 100. CSP(80%) is CSP including information indicating that the remaining battery level of the battery 206 is 80%.

In step F425, the power transmission apparatus 100 transmits a notification indicating that the remaining battery level of the battery 206 is 80% to the control unit 301 of the electronic apparatus 102. In step F428, the control unit 301 of the electronic apparatus 102 displays, on the display unit 307, the remaining battery level of the battery 206 based on the notification in step F425.

In step F426, the power transmission apparatus 100 transmits a notification indicating that power is being transmitted to the power reception apparatus 101 (in other words, the battery 206 is being charged) to the control unit 301 of the electronic apparatus 102. In step F431, the control unit 301 of the electronic apparatus 102 displays, on the display unit 307, information indicating that the battery 206 is being charged based on the notification in step F426.

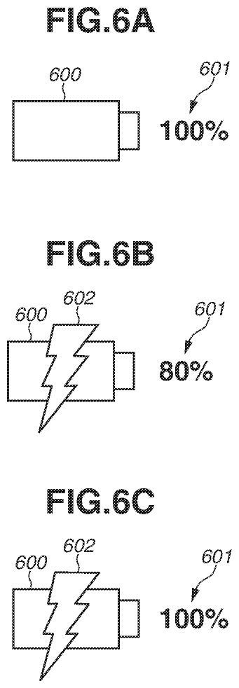

Examples of display on the display unit 307 will now be described with reference to FIGS. 6A to 6C. The display unit 307 displays a battery icon 600 and a remaining battery level 601. The remaining battery level 601 displayed next to the battery icon 600 indicates the remaining battery level of the battery 206 of the power reception apparatus 101. The display unit 307 can also display a charging icon 602. The charging icon 602 indicates that the battery 206 is being charged.

Specifically, according to the display of FIG. 6A, the remaining battery level 601 of the battery 206 is 100%, and the battery 206 is not being charged. According to the display of FIG. 6B, the remaining battery level 601 of the battery 206 is 80%, and the battery 206 is being charged.

The description continues with reference to FIG. 5 again. In steps F424 and F427, the power reception apparatus 101 regularly transmits CSP to the power transmission apparatus 100. The power transmission apparatus 100 transmits a notification indicating the remaining battery level 601 of the battery 206 to the control unit 301 of the electronic apparatus 102 based on the received CSP. The electronic apparatus 102 displays, on the display unit 307, the remaining battery level 601 indicated in the received notification as the remaining battery level 601. In step F428, the control unit 301 of the electronic apparatus 102 displays, on the display unit 307, information indicating that the remaining battery level 601 of the battery 206 is 80% as illustrated in FIG. 6B. In step F431, the control unit 301 of the electronic apparatus 102 displays, on the display unit 307, the charging icon 602 indicating that the battery 206 is being charged as illustrated in FIG. 6B.

In step F427, the power reception apparatus 101 transmits CSP(100%) to the power transmission apparatus 100. The power transmission apparatus 100 transmits a notification indicating that the remaining battery level 601 of the battery 206 is 100% to the control unit 301 of the electronic apparatus 102. The control unit 301 of the electronic apparatus 102 displays, on the display unit 307, the remaining battery level 601 of the battery 206 and the charging icon 602 as illustrated in FIG. 6C based on the notification. According to the display of FIG. 6C, the remaining battery level 601 of the battery 206 is 100%, and the battery 206 is being charged.

In step F422, the power reception apparatus 101 transmits the EPT packet to request the power transmission apparatus 100 to stop the power transmission because the remaining battery level of the battery 206 is 100% and there is no need to charge the battery 206 any longer. Upon receiving the EPT packet, the power transmission apparatus 100 stops the power transmission to the power reception apparatus 101. In step F429, the power transmission apparatus 100 transmits a notification indicating that the power transmission is stopped upon reception of the EPT packet to the control unit 301 of the electronic apparatus 102.

In step F430, the control unit 301 of the electronic apparatus 102 displays, on the display unit 307, information indicating that the remaining battery level 601 of the battery 206 is 100% and the battery 206 is not being charged as illustrated in FIG. 6A. The control unit 301 stops the display of the charging icon 602 to thereby display information indicating that the battery 206 is not being charged. Immediately after step F422, in step F400, the power transmission apparatus 100 transmits the next analog ping to the power reception apparatus 101. In step F423, the power transmission apparatus 100 and the power reception apparatus 101 perform the processing of steps F401 to F416 illustrated in FIG. 4 described above, and then transition to the Power Transfer phase to start power transmission. Almost no time has passed since the remaining battery level 601 of the battery 206 indicates 100% as described above, and thus the remaining battery level 601 is still 100%.

In step F427, the power reception apparatus 101 transmits CSP(100%) including information indicating that the remaining battery level 601 of the battery 206 is 100% to the power transmission apparatus 100. In step F425, the power transmission apparatus 100 transmits a notification indicating that the remaining battery level 601 of the battery 206 is 100% to the control unit 301 of the electronic apparatus 102. In step F428, the control unit 301 of the electronic apparatus 102 displays, on the display unit 307, information indicating that the remaining battery level 601 of the battery 206 is 100% as illustrated in FIG. 6C.

In step F426, the power transmission apparatus 100 transmits a notification indicating that power is being transmitted to the power reception apparatus 101 (in other words, the battery 206 is being charged) to the control unit 301 of the electronic apparatus 102. In step F431, the control unit 301 of the electronic apparatus 102 displays, on the display unit 307, the charging icon 602 indicating that the battery 206 is being charged as illustrated in FIG. 6C based on the notification in step F426.

In step F422, the power reception apparatus 101 transmits the EPT packet to request for stopping power transmission to the power transmission apparatus 100 because the remaining battery level of the battery 206 is 100% and there is no need to charge the battery 206. Upon receiving the EPT packet, the power transmission apparatus 100 stops power transmission to the power reception apparatus 101. In step F429, the power transmission apparatus 100 transmits a notification indicating that the power transmission is stopped upon reception of the EPT packet to the control unit 301 of the electronic apparatus 102. In step F430, the control unit 301 of the electronic apparatus 102 displays, on the display unit 307, information indicating that the remaining battery level 601 of the battery 206 is 100% and the battery 206 is not being charged as illustrated in FIG. 6A. The control unit 301 stops the display of the charging icon 602 to thereby display information indicating that the battery 206 is not being charged.

Immediately after step F422, in step F400, the power transmission apparatus 100 transmits the next analog ping to the power reception apparatus 101. After that, the electronic apparatus 102, the power transmission apparatus 100, and the power reception apparatus 101 repeatedly perform the above-described processing. Then, as described above, the display unit 307 repeats, in a short cycle, switching between the display of FIG. 6C indicating that the battery 206 is being charged in step F431 and the display of FIG. 6A indicating that the battery 206 is not being charged in step F430. This is inconvenient for the user in terms of usability of the electronic apparatus 102, which is an issue to be addressed.

### Processing for Electronic Apparatus 102 according to Present Exemplary Embodiment

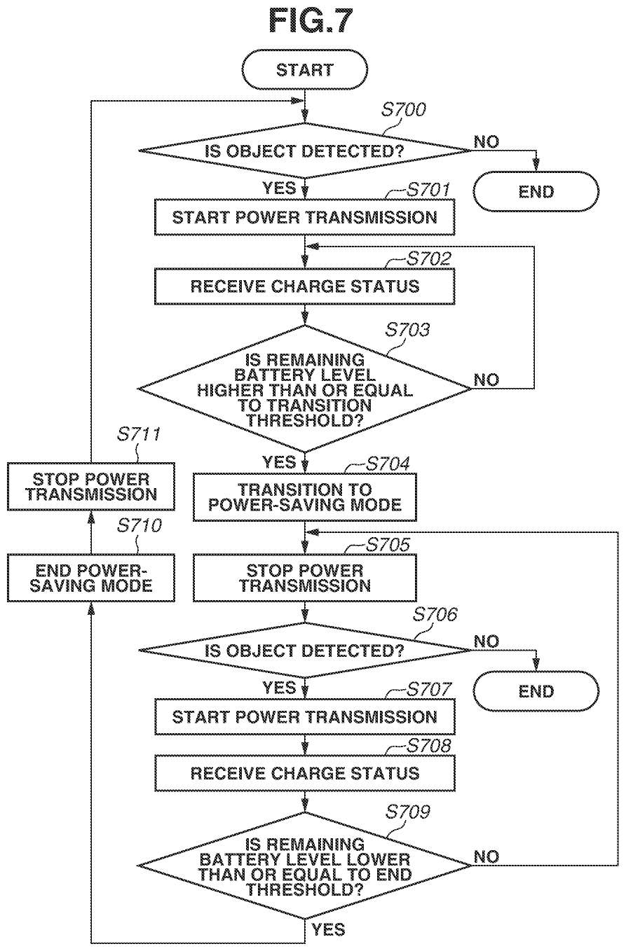

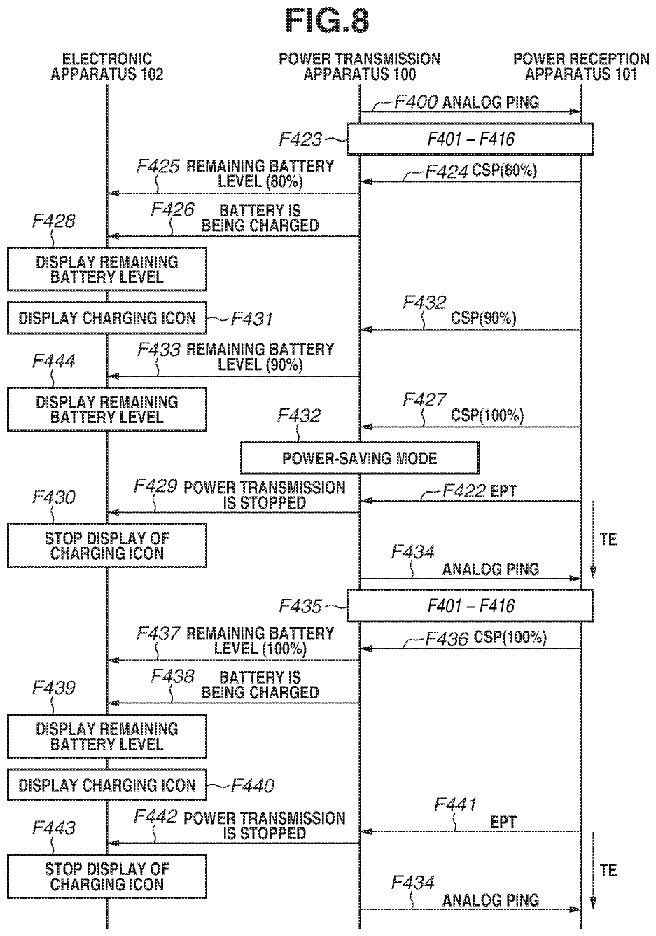

Processing for the electronic apparatus 102 according to the present exemplary embodiment to solve the above-described issue will be described with reference to FIGS. 7 and 8. FIG. 7 is a flowchart illustrating processing in a power-saving mode of the power transmission apparatus 100 according to the present exemplary embodiment.

In step S700, the control unit 300 of the power transmission apparatus 100 transmits an analog ping to detect whether an object is placed on the power transmission coil 304 of the power transmission apparatus 100. Upon detecting that an object is placed thereon, the control unit 300 transmits a digital ping and detects whether the object corresponds to the power reception apparatus 101 compliant with the WPC standard. If the object corresponds to the power reception apparatus 101 compliant with the WPC standard (YES in step S700), the control unit 300 advances the processing to step S701. If the object does not correspond to the power reception apparatus 101 compliant with the WPC standard, or no object is placed (NO in step S700), the control unit 300 ends the processing in the flowchart of FIG. 7.

In step S701, the control unit 300 of the power transmission apparatus 100 starts power transmission to the power reception apparatus 101. In step S702, the power reception apparatus 101 transmits information indicating the remaining battery level of the battery 206 to the power transmission apparatus 100. The control unit 300 of the power transmission apparatus 100 receives the information indicating the remaining battery level of the battery 206 from the power reception apparatus 101. The information indicating the remaining battery level is transmitted in the CSP from the power reception apparatus 101. The term “remaining battery level” used herein refers to a value indicating the percentage of the remaining battery level when energy in a fully charged state is 100%.

The control unit 300 of the power transmission apparatus 100 transmits the received information indicating the remaining battery level of the battery 206 to the control unit 301 of the electronic apparatus 102. The control unit 301 of the electronic apparatus 102 displays, on the display unit 307, the remaining battery level 601 based on the information indicating the remaining battery level of the battery 206.

In step S703, the control unit 300 of the power transmission apparatus 100 determines whether the received remaining battery level is higher than or equal to a transition threshold. The transition threshold is a value stored in the memory 306 of the power transmission apparatus 100, or a value acquired by the power transmission apparatus 100 from the power reception apparatus 101 during a connection sequence after the transmission of the digital ping. For example, the transition threshold is 99%. If the remaining battery level is higher than or equal to the transition threshold (YES in step S703), the control unit 300 advances the processing to step S704. If the remaining battery level is lower than the transition threshold (NO in step S703), the control unit 300 returns the processing to step S702.

In step S704, the control unit 300 of the power transmission apparatus 100 transitions from a normal mode to the power-saving mode. An interval of transmitting an analog ping from the power transmission apparatus 100 in the power-saving mode is longer than that in the normal mode.

Specifically, the power transmission apparatus 100 sets a period of time from the reception of the EPT packet, which is a power transmission end request, from the power reception apparatus 101 to the transmission of the next analog ping in the power-saving mode to be longer than that in the normal mode. For example, in the normal mode, the period of time from the reception of the EPT packet by the power transmission apparatus 100 to the transmission of the analog ping is 100 ms. In the power-saving mode, the period of time from the reception of the EPT packet by the power transmission apparatus 100 to the transmission of the analog ping is 10 minutes.

As another method, the power transmission apparatus 100 may increase the interval between transmission of an analog ping and transmission of another analog ping in the power-saving mode to be longer than that in the normal mode. For example, if a condition for transitioning to the power-saving mode is satisfied, the power transmission apparatus 100 stops power transmission. Alternatively, in the power-saving mode, the power transmission apparatus 100 may designate a period of time in which transmission of the digital ping is stopped. During the period of time in which the transmission of the digital ping is stopped, the power transmission apparatus 100 prevents the digital ping from being transmitted after the analog ping is transmitted, thereby preventing entering a power transmission state.

In step S705, the control unit 300 of the power transmission apparatus 100 stops the power transmission to the power reception apparatus 101 after the EPT packet is received from the power reception apparatus 101. If the condition for transitioning to the power-saving mode is satisfied, the control unit 300 may stop power transmission even when the EPT packet is not received.

In step S706, the control unit 300 of the power transmission apparatus 100 transmits an analog ping after the lapse of the period of time set in the power-saving mode, and detects whether an object is placed on the power transmission coil 304 of the power transmission apparatus 100. Upon detecting that an object is placed thereon, the control unit 300 transmits a digital ping and detects whether the object corresponds to the power reception apparatus 101 compliant with the WPC standard. If the object corresponds to the power reception apparatus 101 compliant with the WPC standard (YES in step S706), the control unit 300 advances the processing to step S707. If the object does not correspond to the power reception apparatus 101 compliant with the WPC standard, or no object is placed thereon (NO in step S706), the control unit 300 ends the processing in the flowchart of FIG. 7.

In step S707, the control unit 300 of the power transmission apparatus 100 starts power transmission to the power reception apparatus 101. The control unit 300 transmits an analog ping and a digital ping before receiving CSP from the power reception apparatus 101. However, in the power-saving mode, it takes a long time to transmit the analog ping. Accordingly, the period of time from when the power transmission is stopped in step S705 to when the power transmission is started in step S707 is also long.

In step S708, the control unit 300 of the power transmission apparatus 100 receives CSP including information indicating the remaining battery level of the battery 206 from the power reception apparatus 101. The control unit 300 transmits the received information indicating the remaining battery level of the battery 206 to the control unit 301 of the electronic apparatus 102. The control unit 301 of the electronic apparatus 102 displays, on the display unit 307, the remaining battery level 601 based on the information indicating the remaining battery level of the battery 206.

In step S709, the control unit 300 of the power transmission apparatus 100 determines whether the remaining battery level included in the CSP is lower than or equal to an end threshold. The end threshold is a value stored in the memory 306 of the power transmission apparatus 100, or a value acquired by the power transmission apparatus 100 from the power reception apparatus 101 during a connection sequence after the transmission of the digital ping. For example, the end threshold is 95%. If the remaining battery level is lower than or equal to the end threshold (YES in step S709), the control unit 300 advances the processing to step S710. If the remaining battery level is not lower than or equal to the end threshold (NO in step S709), the control unit 300 returns the processing to step S705.

In step S710, the control unit 300 of the power transmission apparatus 100 ends the power-saving mode and transitions to the normal mode. If the control unit 300 ends the power-saving mode, the analog ping transmission interval is set to that in the normal mode. The analog ping transmission interval in the normal mode is shorter than the analog ping transmission interval in the power-saving mode. Specifically, the power transmission apparatus 100 shortens the period of time from when the EPT packet, which is the power transmission end request, is received from the power reception apparatus 101 to when the next analog ping is transmitted. For example, the period of time from when the power transmission apparatus 100 receives the EPT packet to when the analog ping is transmitted is 10 minutes in the power-saving mode and is 100 ms in the normal mode.

As another method, the power transmission apparatus 100 may shorten the interval between transmission of an analog ping and transmission of another analog ping.

In step S711, the control unit 300 of the power transmission apparatus 100 stops the power transmission to the power reception apparatus 101, and then returns the processing to step S700.

Thus, the power transmission apparatus 100 transitions from the normal mode to the power-saving mode, which increases the period of time during which the power transmission is stopped and prevents the display of charging from being frequently changed.

FIG. 8 is a sequence diagram illustrating a control method for the electronic apparatus 102, the power transmission apparatus 100, and the power reception apparatus 101 according to the present exemplary embodiment when the processing in the flowchart of FIG. 7 is applied. In descriptions of FIG. 8, steps that are similar to those described above with reference to FIGS. 4 and 5 are denoted by the same step numbers, and descriptions thereof are omitted.

In step F400, the control unit 300 of the power transmission apparatus 100 transmits an analog ping to the power reception apparatus 101. In step F423, the power transmission apparatus 100 and the power reception apparatus 101 perform the processing of steps F401 to F416 illustrated in FIG. 4 as described above, and then transition to the Power Transfer phase to start power transmission.

In step F424, the power reception apparatus 101 transmits CSP(80%) including information indicating that the remaining battery level of the battery 206 is 80% to the power transmission apparatus 100. In step S702, the control unit 300 of the power transmission apparatus 100 receives the CSP(80%) from the power reception apparatus 101. In step S703, the control unit 300 maintains the normal mode since the remaining battery level (80%) is not higher than or equal to the transition threshold (99%). Then, the processing returns to step S702.

In step F425, the control unit 300 of the power transmission apparatus 100 transmits a notification indicating that the remaining battery level of the battery 206 is 80% to the control unit 301 of the electronic apparatus 102. In step F426, the control unit 300 of the power transmission apparatus 100 transmits a notification indicating that power is being transmitted to the power reception apparatus 101 (in other words, the battery 206 is being charged) to the control unit 301 of the electronic apparatus 102.

In step F428, the control unit 301 of the electronic apparatus 102 displays, on the display unit 307, information indicating that the remaining battery level 601 of the battery 206 is 80% as illustrated in FIG. 6B.

In step S431, the control unit 301 displays, on the display unit 307, the charging icon 602 indicating that the battery 206 is being charged as illustrated in FIG. 6B.

In step F432, the power reception apparatus 101 transmits CSP(90%) including information indicating that the remaining battery level of the battery 206 is 90% to the power transmission apparatus 100. In step S702, the control unit 300 of the power transmission apparatus 100 receives the CSP(90%) from the power reception apparatus 101. In step S703, the control unit 300 maintains the normal mode since the remaining battery level (90%) is not higher than or equal to the transition threshold (99%). Then, the processing returns to step S702.

In step F433, the control unit 300 of the power transmission apparatus 100 transmits, to the control unit 301 of the electronic apparatus 102, a notification indicating that the remaining battery level of the battery 206 is 90% and power is being transmitted. In step F444, the control unit 301 of the electronic apparatus 102 displays, on the display unit 307, information indicating that the remaining battery level 601 of the battery 206 is 90% and the charging icon 602.

In step F427, the power reception apparatus 101 transmits CSP(100%) including information indicating that the remaining battery level of the battery 206 is 100% to the power transmission apparatus 100. In step S702, the control unit 300 of the power transmission apparatus 100 receives the CSP(100%) from the power reception apparatus 101. In step S703, the control unit 300 advances the processing to step S704 since the remaining battery level (100%) is higher than or equal to the transition threshold (99%).

The control unit 300 transmits, to the control unit 301 of the electronic apparatus 102, a notification indicating that the remaining battery level of the battery 206 is 100% and power is being transmitted. As illustrated in FIG. 6C, the control unit 301 of the electronic apparatus 102 displays, on the display unit 307, information indicating that the remaining battery level 601 of the battery 206 is 100% and the charging icon 602.

In step F432, the control unit 300 performs the processing of step S704. In step S704, the control unit 300 transitions from the normal mode to the power-saving mode, and changes a period of time TE from the reception of the EPT packet to the transmission of the analog ping from 100 ms to 10 minutes.

In step F422, the power reception apparatus 101 transmits the EPT packet to request the power transmission apparatus 100 to stop the power transmission because the remaining battery level of the battery 206 is 100% and there is no need to charge the battery 206 any longer. In step S705, upon receiving the EPT packet, the control unit 300 stops the power transmission to the power reception apparatus 101.

In step F429, the control unit 300 of the power transmission apparatus 100 transmits a notification indicating that the power transmission is stopped upon reception of the EPT packet to the control unit 301 of the electronic apparatus 102. In step F430, the control unit 301 of the electronic apparatus 102 displays, on the display unit 307, information indicating that the remaining battery level 601 is 100% as illustrated in FIG. 6A and stops the display of the charging icon 602.

In step F434, the control unit 300 of the power transmission apparatus 100 transmits an analog ping (S706) after the lapse of the period of time TE (10 minutes) from the reception of the EPT packet in step F422. In step F435, the power transmission apparatus 100 and the power reception apparatus 101 perform the processing of steps F401 to F416 illustrated in FIG. 4, and then transition to the Power Transfer phase to start power transmission (S706 and S707).

In step F436, the power reception apparatus 101 transmits CSP(100%) including information indicating that the remaining battery level of the battery 206 is 100% to the power transmission apparatus 100. In step S708, the control unit 300 of the power transmission apparatus 100 receives the CSP(100%) from the power reception apparatus 101. In step S709, the control unit 300 maintains the power-saving mode since the remaining battery level (100%) is not lower than or equal to the end threshold (95%), and maintains the period of time TE of 10 minutes. Then, the processing returns to step S705.

In step F437, the control unit 300 of the power transmission apparatus 100 transmits a notification indicating that the remaining battery level of the battery 206 is 100% to the control unit 301 of the electronic apparatus 102. In step F438, the control unit 300 of the power transmission apparatus 100 transmits a notification indicating that power is being transmitted to the power reception apparatus 101 (in other words, the battery 206 is being charged) to the control unit 301 of the electronic apparatus 102.

In step F439, the control unit 301 of the electronic apparatus 102 displays, on the display unit 307, information indicating that the remaining battery level 601 of the battery 206 is 100% as illustrated in FIG. 6C. In step S440, the control unit 301 displays, on the display unit 307, the charging icon 602 indicating that the battery 206 is being charged as illustrated in FIG. 6C.

In step F441, the power reception apparatus 101 transmits the EPT packet to request the power transmission apparatus 100 to stop the power transmission because the remaining battery level of the battery 206 is 100% and there is no need to charge the battery 206 any longer. In step S705, upon receiving the EPT packet, the control unit 300 stops the power transmission to the power reception apparatus 101.

In step F442, the control unit 300 of the power transmission apparatus 100 transmits a notification indicating that the power transmission is stopped upon reception of the EPT packet to the control unit 301 of the electronic apparatus 102. In step F443, the control unit 301 of the electronic apparatus 102 displays, on the display unit 307, information indicating that the remaining battery level 601 is 100% as illustrated in FIG. 6A and stops the display of the charging icon 602.

In step F434, the control unit 300 of the power transmission apparatus 100 transmits an analog ping (S706) after the lapse of the period of time TE (10 minutes) from the reception of the EPT packet in step F441. After that, the electronic apparatus 102, the power transmission apparatus 100, and the power reception apparatus 101 repeatedly perform the processing of step F435 and subsequent steps described above.

After that, the remaining battery level of the battery 206 gradually decreases. In step S709, if the remaining battery level becomes lower than or equal to the end threshold (95%), the control unit 300 advances the processing to step S710. The control unit 300 transitions to the normal mode and sets the period of time TE to 100 ms. In step S711, the control unit 300 stops the power transmission, and then the processing returns to step S700.

As described above, in the present exemplary embodiment, the control unit 300 determines whether to transition to the power-saving mode depending on the remaining battery level included in CSP. If the remaining battery level is higher than or equal to the transition threshold (99%), the control unit 300 transitions to the power-saving mode and sets the longer period of time TE (10 minutes), thereby preventing the power transmission start operation and the power transmission stop operation from being frequently repeated. As a result, the charging icon 602 on the display unit 307 is prevented from rapidly blinking, thereby inconvenience for the user can be prevented.

The control unit 300 sets the end threshold (95%) to be smaller than the transition threshold (99%), thereby obtaining effects of preventing the normal mode and the power-saving mode from being frequently switched and preventing rapid blinking of the charging icon 602 of the power reception apparatus 101 in which the battery 206 is consumed quickly.

An example where the power reception apparatus 101 regularly transmits CSP to the power transmission apparatus 100 in the Power Transfer phase has been described above. Alternatively, CSP may be irregularly transmitted.

The power transmission apparatus 100 may regularly or irregularly request the power reception apparatus 101 to transmit CSP, and the power reception apparatus 101 may transmit a notification about CSP to the power transmission apparatus 100 in response to the request. Examples of the requesting method include a method of transmitting a request packet from the power transmission apparatus 100 to the power reception apparatus 101. The request packet is a packet indicating that the power transmission apparatus 100 requests the power reception apparatus 101 to perform an operation. After that, the power transmission apparatus 100 transmits a packet (request operation identification packet) including identification information for identifying the requested operation to the power reception apparatus 101. These two operations may be performed using one packet. Specifically, the power transmission apparatus 100 may transmit, to the power reception apparatus 101, a packet that indicates that the power transmission apparatus 100 requests the power reception apparatus 101 to perform an operation and that includes the identification information for identifying the requested operation. The power reception apparatus 101 that has received the request packet and the request operation identification packet transmits CSP to the power transmission apparatus 100. Further, if a predetermined condition is satisfied, the power transmission apparatus 100 may request the power reception apparatus 101 to transmit CSP, and the power reception apparatus 101 may transmit a notification about CSP to the power transmission apparatus 100 in response to the request. For example, the predetermined condition may be a case where the power transmission apparatus 100 receives the EPT packet a plurality of times (e.g., twice) from the power reception apparatus 101 within a certain period (e.g., 10 seconds). In this case, in step F422, the power transmission apparatus 100 receives the EPT packet, stops the power transmission, and gets ready for transmitting the next analog ping. Accordingly, it is necessary to avoid the state illustrated in FIG. 5. In this case, the power transmission apparatus 100 may acquire the remaining battery level by CSP and may perform control illustrated in FIG. 7.

The power reception apparatus 101 may transmit a notification about CSP to the power transmission apparatus 100 in the Negotiation phase, or the power transmission apparatus 100 may request the power reception apparatus 101 to transmit CSP, and the power reception apparatus 101 may transmit a notification about CSP corresponding to the request to the power transmission apparatus 100.

While, in the present exemplary embodiment, an example is described where predetermined fixed values are used as the transition threshold and the end threshold, the transition threshold and the end threshold may be determined through negotiation between the power transmission apparatus 100 and the power reception apparatus 101 in the Negotiation phase. For example, for the power reception apparatus 101 including the battery 206 with a small capacity, because the remaining battery level of the battery 206 easily increases by charging, the end threshold is set to a relatively small value (e.g., end threshold=90%, transition threshold=97%). This makes it possible to increase the time interval between repetitions of display and non-display of the charging icon 602. Accordingly, the power reception apparatus 101 may negotiate for a relatively low transition threshold in the negotiation.

As described above, the power transmission unit 303 wirelessly transmits power to the power reception apparatus 101. While the power transmission unit 303 is transmitting power, the control unit 301 controls the charging icon 602 indicating that the power reception apparatus 101 is being charged to be displayed. When the power transmission unit 303 stops power transmission, the control unit 301 controls the display of the charging icon 602 indicating that the power reception apparatus 101 is being charged to be stopped.

The power transmission unit 303 transitions from the normal mode to the power-saving mode in which the period of time from when the power transmission is stopped by the power transmission unit 303 to when power transmission for detecting an object is performed is longer than that in the normal mode, based on information about the power reception apparatus 101. The information about the power reception apparatus 101 is, for example, the remaining battery level of the power reception apparatus 101. The communication unit 305 serves as a reception unit to receive the remaining battery level of the power reception apparatus 101 from the power reception apparatus 101.

The period of time TE (10 minutes) from when the power transmission unit 303 stops power transmission to when the power transmission unit 303 starts power transmission in the power-saving mode is longer than the period of time TE (100 ms) from when the power transmission unit 303 stops power transmission to when the power transmission unit 303 starts power transmission in the normal mode. The period of time during which power transmission is stopped in the power-saving mode is longer than the period of time during which power transmission is stopped in the normal mode. Further, the interval of analog pings transmitted from the power transmission unit 303 in the power-saving mode may be longer than the interval of analog pings transmitted from the power transmission unit 303 in the normal mode.

In step S703, if the remaining battery level of the power reception apparatus 101 is higher than the transition threshold, the processing proceeds to step S704, and the power transmission unit 303 transitions to the power-saving mode. In step S709, if the remaining battery level of the power reception apparatus 101 is lower than or equal to the end threshold, the processing proceeds to step S710, and the power transmission unit 303 transitions to the normal mode. The end threshold is lower than or equal to the transition threshold.

In steps S702 and S708, the communication unit 305 receives the remaining battery level of the power reception apparatus 101 in CSP of the WPC standard. The communication unit 305 receives, from the power reception apparatus 101, the remaining battery level of the power reception apparatus 101 that is superimposed on power from the power transmission unit 303. The communication unit 305 receives the remaining battery level of the power reception apparatus 101 by amplitude-shift keying (ASK) modulation or frequency-shift keying (FSK) modulation.

The communication unit 305 may serve as a transmission unit to transmit a request for the remaining battery level of the power reception apparatus 101 to the power reception apparatus 101, and may receive the remaining battery level of the power reception apparatus 101 corresponding to the request from the power reception apparatus 101. Further, the communication unit 305 may receive the remaining battery level of the power reception apparatus 101 based on a Bluetooth® Low Energy standard.

According to the present exemplary embodiment, the electronic apparatus 102 can increase the period of time TE from when display of information indicating that the power reception apparatus 101 is being charged is stopped to when the information indicating that the power reception apparatus 101 is being charged is displayed in the power-saving mode. Thus, the electronic apparatus 102 can prevent the display and non-display of the information indicating that the power reception apparatus 101 is being charged from being rapidly repeated.

### Second Exemplary Embodiment

In the first exemplary embodiment, the power transmission apparatus 100 transitions to the power-saving mode depending on the remaining battery level included in the received CSP, and sets the long period of time TE (10 minutes). In a second exemplary embodiment, the power transmission apparatus 100 sends a request for temperature information about the power reception apparatus 101, transitions to the power-saving mode depending on the received temperature information, and sets the long period of time TE (10 minutes).

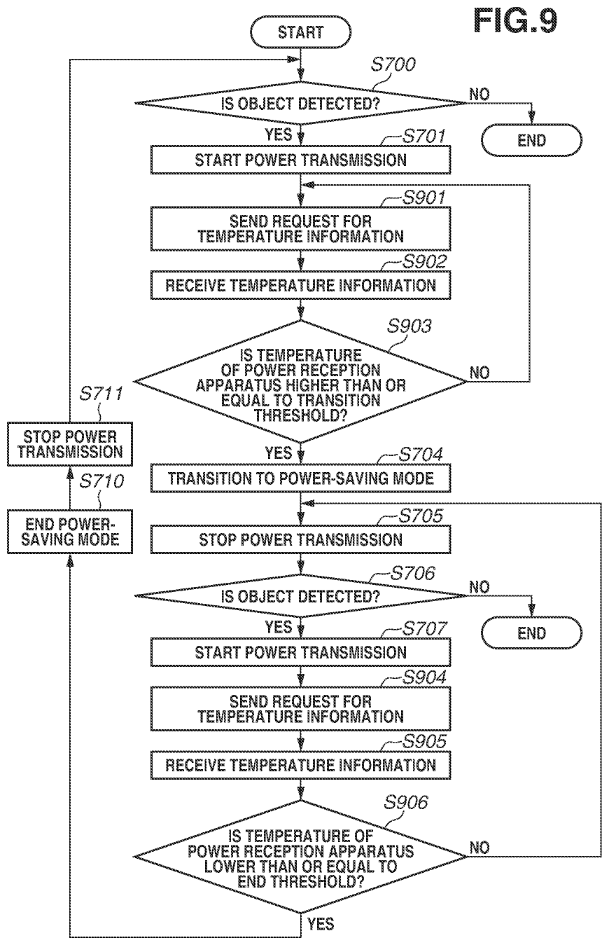

FIG. 9 is a flowchart illustrating processing in the power-saving mode of the power transmission apparatus 100 according to the second exemplary embodiment. FIG. 9 differs from FIG. 7 in that steps S702, S703, S708, and S709 are removed and steps S901 to S906 are added. Steps in FIG. 9 that are identical to those in FIG. 7 are denoted by the same step numbers, and descriptions thereof are simplified. Differences between the second exemplary embodiment and the first exemplary embodiment will be described below.

In step S700, the control unit 300 of the power transmission apparatus 100 transmits an analog ping to detect whether an object is placed on the power transmission coil 304 of the power transmission apparatus 100. Upon detecting that an object is placed thereon, the control unit 300 transmits a digital ping and detects whether the object corresponds to the power reception apparatus 101 compliant with the WPC standard. If the object corresponds to the power reception apparatus 101 compliant with the WPC standard (YES in step S700), the control unit 300 advances the processing to step S701. If the object does not correspond to the power reception apparatus 101 compliant with the WPC standard, or no object is placed (NO in step S700), the control unit 300 ends the processing in the flowchart of FIG. 9.

In step S701, the control unit 300 of the power transmission apparatus 100 starts power transmission to the power reception apparatus 101.

In step S901, the control unit 300 of the power transmission apparatus 100 requests the power reception apparatus 101 to send a transition temperature and a current temperature as the temperature information about the power reception apparatus 101. The transition temperature corresponds to the transition threshold. The power reception apparatus 101, in response to the request, transmits the transition temperature and the current temperature as the temperature information about the power reception apparatus 101 to the power transmission apparatus 100.

In step S902, the control unit 300 of the power transmission apparatus 100 receives, from the power reception apparatus 101, the transition temperature (e.g., 70° C.) and the current temperature (e.g., 60° C.) as the temperature information about the power reception apparatus 101.

In step S903, the control unit 300 of the power transmission apparatus 100 sets the transition temperature of the power reception apparatus 101 as the transition threshold and determines whether the current temperature of the power reception apparatus 101 is higher than or equal to the transition threshold. If the current temperature of the power reception apparatus 101 is not higher than or equal to the transition threshold (NO in step S903), the control unit 300 returns the processing to step S901. If the current temperature of the power reception apparatus 101 is higher than or equal to the transition threshold (YES in step S903), the control unit 300 advances the processing to step S704.

In step S704, the control unit 300 of the power transmission apparatus 100 transitions from the normal mode to the power-saving mode, and sets the period of time TE to 10 minutes.

In step S705, the control unit 300 of the power transmission apparatus 100 stops the power transmission to the power reception apparatus 101 after the EPT packet is received from the power reception apparatus 101.

In step S706, the control unit 300 of the power transmission apparatus 100 transmits an analog ping after the lapse of the period of time TE, and detects whether an object is placed on the power transmission coil 304 of the power transmission apparatus 100. If the control unit 300 detects that an object is placed thereon, the control unit 300 transmits a digital ping and detects whether the object corresponds to the power reception apparatus 101 compliant with the WPC standard. If the object corresponds to the power reception apparatus 101 compliant with the WPC standard (YES in step S706), the control unit 300 advances the processing to step S707. If the object does not correspond to the power reception apparatus 101 compliant with the WPC standard, or no object is placed thereon (NO in step S706), the control unit 300 ends the processing in the flowchart of FIG. 9.

In step S707, the control unit 300 of the power transmission apparatus 100 starts power transmission to the power reception apparatus 101.

In step S904, the control unit 300 of the power transmission apparatus 100 requests the power reception apparatus 101 to send an end temperature and the current temperature as the temperature information about the power reception apparatus 101. The end temperature corresponds to the end threshold. The power reception apparatus 101, in response to the request, transmits the end temperature and the current temperature as the temperature information about the power reception apparatus 101 to the power transmission apparatus 100.

In step S902, the control unit 300 of the power transmission apparatus 100 receives, from the power reception apparatus 101, the end temperature (e.g., 65° C.) and the current temperature as the temperature information about the power reception apparatus 101.

In step S906, the control unit 300 of the power transmission apparatus 100 sets the end temperature of the power reception apparatus 101 as the end threshold and determines whether the current temperature of the power reception apparatus 101 is lower than or equal to the end threshold. If the current temperature of the power reception apparatus 101 is not lower than or equal to the end threshold (NO in step S906), the control unit 300 returns the processing to step S705. If the current temperature of the power reception apparatus 101 is lower than or equal to the end threshold (YES in step S906), the control unit 300 advances the processing to step S710. The transition threshold and the end threshold may be values stored in the memory 306 of the power transmission apparatus 100, or values acquired by the power transmission apparatus 100 from the power reception apparatus 101 during a connection sequence after the transmission of the digital ping.

In step S710, the control unit 300 of the power transmission apparatus 100 ends the power-saving mode, transitions to the normal mode, and sets the period of time TE to 100 ms.

In step S711, the control unit 300 of the power transmission apparatus 100 stops the power transmission to the power reception apparatus 101, and then returns the processing to step S700.

As described above, according to the present exemplary embodiment, if the temperature of the power reception apparatus 101 is higher than or equal to the transition threshold, the control unit 300 transitions to the power-saving mode. If the temperature of the power reception apparatus 101 is lower than or equal to the end threshold, the control unit 300 ends the power-saving mode. Consequently, the control unit 300 can prevent the period of time during which the power transmission is stopped from being increased and prevent the display of the charging icon 602 from being frequently changed in the power-saving mode.

As described above, the power transmission unit 303 transitions from the normal mode to the power-saving mode in which the period of time from when the power transmission is stopped by the power transmission unit 303 to when the power transmission for detecting an object is performed is longer than that in the normal mode, based on information about the power reception apparatus 101. The information about the power reception apparatus 101 is, for example, the temperature of the power reception apparatus 101.

In step S903, if the temperature of the power reception apparatus 101 is higher than the transition threshold (YES in step S903), the control unit 300 advances the processing to step S704. In step S704, the power transmission unit 303 transitions to the power-saving mode. In step S906, if the temperature of the power reception apparatus 101 is lower than or equal to the end threshold (YES in step S906), the control unit 300 advances the processing to step S710. In step S710, the power transmission unit 303 transitions to the normal mode. The end threshold is lower than or equal to the transition threshold.

In steps S901 and S904, the communication unit 305 transmits a request for the temperature of the power reception apparatus 101 to the power reception apparatus 101. In steps S902 and S905, the communication unit 305 receives the temperature of the power reception apparatus 101 corresponding to the request from the power reception apparatus 101. The communication unit 305 receives the temperature of the power reception apparatus 101 that is superimposed on power from the power transmission unit 303. The communication unit 305 receives the temperature of the power reception apparatus 101 by ASK modulation or FSK modulation. Further, the communication unit 305 may receive the temperature of the power reception apparatus 101 based on a Bluetooth® Low Energy standard.

According to the present exemplary embodiment, the electronic apparatus 102 can increase the period of time TE from when display of information indicating that the power reception apparatus 101 is being charged is stopped to when the information indicating that the power reception apparatus 101 is being charged is displayed in the power-saving mode. Thus, the electronic apparatus 102 can prevent the display and non-display of the information indicating that the power reception apparatus 101 is being charged from being rapidly repeatedly.

### Other Exemplary Embodiments

In the first and second exemplary embodiments, the power transmission apparatus 100 receives the remaining battery level of the battery 206 or the temperature of the power reception apparatus 101 from the power reception apparatus 101. However, the present invention is not limited to these examples. The power transmission apparatus 100 may acquire, from the power reception apparatus 101, the remaining battery level of the battery 206 or the temperature of the power reception apparatus 101 by Bluetooth® Low Energy communication. In this case, the communication unit 305 in the power transmission apparatus 100 and the communication unit 204 in the power reception apparatus 101 are configured to perform communication based on Bluetooth® Low Energy.

Further, if the control unit 300 acquires wired charging start information when a charging cable is connected between the power transmission apparatus 100 and the power reception apparatus 101, the control unit 300 may transition to the power-saving mode and may stop wireless power transmission. If the charging cable between the power transmission apparatus 100 and the power reception apparatus 101 is disconnected, the control unit 300 ends the power-saving mode and transitions to the normal mode.

The power transmission unit 303 transitions from the normal mode to the power-saving mode in which the period of time from when the power transmission is stopped by the power transmission unit 303 to when power transmission for detecting an object is performed is longer than that in the normal mode, based on information about the power reception apparatus 101. The information about the power reception apparatus 101 is, for example, information indicating that the electronic apparatus 102 or the power transmission apparatus 100 has started wired power transmission to the power reception apparatus 101. Further, if the electronic apparatus 102 or the power transmission apparatus 100 ends the wired power transmission to the power reception apparatus 101, the power transmission unit 303 transitions from the power-saving mode to the normal mode.

The processing of FIGS. 7 to 9 can be implemented, for example, by the control units 200, 300, and 301 reading programs preliminarily stored and executing the programs to thereby control each functional unit. However, the present invention is not limited to this example. At least a part of the processing may be implemented by hardware. If the processing is implemented by hardware, for example, a predetermined compiler may be used to automatically generate a dedicated circuit on a field-programmable gate array (FPGA) using a program for implementing each processing step. Similar to the FPGA, a gate array circuit may be formed to implement hardware for executing at least a part of the above-described processing.

Examples of the electronic apparatus 102 incorporating the power transmission apparatus 100, or the power reception apparatus 101 may include an image capturing apparatus (camera, video camera, etc.), an image input apparatus such as a scanner, and an image output apparatus such as a printer, a copying machine, or a projector. The examples may also include a storage device such as a hard disk device or a memory device, or an information processing apparatus such as a PC or a smartphone.

The power reception apparatus 101 according to the present disclosure may be an information terminal apparatus. For example, the information terminal apparatus includes a display unit (display) that is supplied with power received from a power reception antenna and displays information for the user. The power received from the power reception antenna is stored in an electric battery unit (battery), and the battery supplies power to the display unit. In this case, the power reception apparatus 101 may include a communication unit that communicates with another apparatus different from the power transmission apparatus 100. The communication unit may be compliant with communication standards, such as near-field communication (NFC) or fifth-generation mobile communication system (5G).

The power reception apparatus 101 according to the present disclosure may be a vehicle, such as an automobile. For example, an automobile that is the power reception apparatus 101 may receive power from a charger (electronic apparatus incorporating the power transmission apparatus) via a power transmission antenna installed in a parking lot. In such an automobile, the received power is supplied to a battery. The power in the battery may be supplied to an actuating unit (motor, electrically-driven unit) for driving wheels, or may be used to drive a sensor for driving assistance or to drive a communication unit that communicates with an external apparatus. In other words, in this case, the power reception apparatus 101 may include not only wheels, but also a battery, a motor and a sensor to be driven using received power, and a communication unit that communicates with an apparatus other than the power transmission apparatus 100. The power reception apparatus 101 may further include an accommodation unit that accommodates people. Examples of the sensor include a sensor used to measure a distance between vehicles or a distance from another obstacle. The communication unit may support, for example, a global positioning system or a global positioning satellite (GPS). The communication unit may be compliant with communication standards such as the fifth-generation mobile communication system (5G). Examples of the vehicle may include a bicycle and a motorcycle.

The power reception apparatus 101 according to the present disclosure may be an electric power tool, home appliances, or the like. Such an apparatus that is the power reception apparatus 101 may include a battery and a motor to be driven by received power stored in the battery. The apparatus may also include a notification unit that transmits a notification about the remaining battery level or the like. The apparatus may also include a communication unit that communicates with another apparatus different from the power transmission apparatus 100. The communication unit may be compliant with communication standards, such as the NFC or the fifth-generation mobile communication system (5G).

The power transmission apparatus 100 according to the present disclosure may be an on-vehicle charger for transmitting power to a mobile information terminal device, such as a smartphone or a tablet, which supports wireless power transmission, in an automobile. In this case, the electronic apparatus 102 incorporating the power transmission apparatus 100 may be an apparatus that is mounted on a vehicle, such as an automobile, and manages charging, or may be the vehicle itself. Such an on-vehicle charger may be provided at any location within the automobile. The on-vehicle charger may be installed, for example, on a console of an automobile, an instrument panel, or a dashboard, at a location between passenger seats, or on a ceiling or a door. However, it may be desirable to install the on-vehicle charger at a location that does not interfere with user's driving operation. An example where an on-vehicle charger serves as the power transmission apparatus 100 is described above. However, the charger is not limited to a charger disposed in a vehicle, but instead may be a charger installed on a means of transport, such as a train, an aircraft, or a ship. Also, in this case, the charger may be installed at a location between passenger seats, or on a ceiling or a door.

Alternatively, the power transmission apparatus 100 may be a vehicle, such as an automobile including an on-vehicle charger. In this case, the power transmission apparatus 100 includes wheels and a battery and supplies power in the battery to the power reception apparatus 101 using a power transmission circuit unit or a power transmission antenna.

The above-described exemplary embodiments are merely specific examples for carrying out the present disclosure, and the technical scope of the present disclosure should not be interpreted in a limited manner by the exemplary embodiments. In other words, the present disclosure can be carried out in various forms without departing from the technical idea or main features thereof.

The present disclosure is not limited to the above-described exemplary embodiments, and various alterations and modifications can be made without departing from the spirit and scope of the present disclosure. Accordingly, the following claims are attached to publicize the scope of the present disclosure.

This application claims the benefit of Japanese Patent Application No. 2021-110608, filed Jull 2, 2021, which is hereby incorporated by reference herein in its entirety.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

According to the present disclosure, it is possible to prevent display and non-display of information indicating that a power reception apparatus is being charged from being repeatedly switched.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electronic apparatus comprising:
a power transmission unit configured to wirelessly transmit power to a power reception apparatus; and
a control unit configured to perform control to display information indicating that the power reception apparatus is being charged in a case where the power transmission unit is transmitting power, and to stop displaying the information indicating that the power reception apparatus is being charged in a case where the power transmission unit has stopped power transmission,
wherein the power transmission unit transitions from a normal mode to a power-saving mode based on information about the power reception apparatus, the power-saving mode having a period of time from when the power transmission unit stops the power transmission to when the power transmission unit starts power transmission for detecting an object longer than the period of time of the normal mode.

2. The electronic apparatus according to claim 1,
wherein the information about the power reception apparatus is a remaining battery level of the power reception apparatus, and
wherein the electronic apparatus further comprises a reception unit configured to receive the remaining battery level of the power reception apparatus from the power reception apparatus.

3. The electronic apparatus according to claim 1,
wherein the information about the power reception apparatus is a temperature of the power reception apparatus, and
wherein the electronic apparatus further comprises a reception unit configured to receive the temperature of the power reception apparatus from the power reception apparatus.

4. The electronic apparatus according to claim 1, wherein the information about the power reception apparatus is information indicating that the electronic apparatus has started wired power transmission to the power reception apparatus.

5. The electronic apparatus according to claim 1, wherein an interval between power transmissions by the power transmission unit in the power-saving mode is longer than an interval between power transmissions by the power transmission unit in the normal mode.

6. The electronic apparatus according to claim 2, wherein the power transmission unit transitions to the power-saving mode in a case where the remaining battery level of the power reception apparatus is higher than a first threshold.

7. The electronic apparatus according to claim 6, wherein the power transmission unit transitions to the normal mode in a case where the remaining battery level of the power reception apparatus is lower than a second threshold.

8. The electronic apparatus according to claim 7, wherein the second threshold is lower than or equal to the first threshold.

9. The electronic apparatus according to claim 3, wherein the power transmission unit transitions to the power-saving mode in a case where the temperature of the power reception apparatus is higher than a first threshold.

10. The electronic apparatus according to claim 9, wherein the power transmission unit transitions to the normal mode in a case where the temperature of the power reception apparatus is lower than a second threshold.

11. The electronic apparatus according to claim 10, wherein the second threshold is lower than or equal to the first threshold.

12. The electronic apparatus according to claim 4, wherein the power transmission unit transitions to the normal mode in a case where the electronic apparatus has completed the wired power transmission to the power reception apparatus.

13. The electronic apparatus according to claim 2, wherein the reception unit receives the remaining battery level of the power reception apparatus in a charge status packet of a Wireless Power Consortium (WPC) standard.

14. The electronic apparatus according to claim 2, further comprising a transmission unit configured to transmit a request for one of the remaining battery level and a temperature of the power reception apparatus to the power reception apparatus,
wherein the reception unit receives one of the remaining battery level and the temperature of the power reception apparatus corresponding to the request from the power reception apparatus.

15. The electronic apparatus according to claim 2, wherein the reception unit receives, from the power reception apparatus, one of the remaining battery level and a temperature of the power reception apparatus being superimposed on the power.

16. The electronic apparatus according to claim 15, wherein the reception unit receives one of the remaining battery level and the temperature of the power reception apparatus by one of amplitude-shift keying (ASK) modulation and frequency-shift keying (FSK) modulation.

17. The electronic apparatus according to claim 2, wherein the reception unit receives one of the remaining battery level and a temperature of the power reception apparatus based on a Bluetooth® Low Energy standard.

18. A method for an electronic apparatus, the control method comprising:
wirelessly transmitting power to a power reception apparatus;
performing control to display information indicating that the power reception apparatus is being charged in a case where the power is being transmitted, and to stop displaying the information indicating that the power reception apparatus is being charged in a case where power transmission is stopped; and
transitioning from a normal mode to a power-saving mode based on information about the power reception apparatus, the power-saving mode having a period of time from when the power transmission is stopped to when power transmission for detecting an object is started longer than the period of time of the normal mode.

19. A non-transitory computer readable storage medium storing a program for causing a computer to execute a method for an electronic apparatus, the control method comprising:
wirelessly transmitting power to a power reception apparatus;
performing control to display information indicating that the power reception apparatus is being charged in a case where the power is being transmitted, and to stop displaying the information indicating that the power reception apparatus is being charged in a case where power transmission is stopped; and
transitioning from a normal mode to a power-saving mode based on information about the power reception apparatus, the power-saving mode having a period of time from when the power transmission is stopped to when power transmission for detecting an object is started longer than the period of time of the normal mode.
